(19) United States
(12) Patent Application Publication
(10) Pub. No.: US 2012/0090920 A1
(43) Pub. Date: Apr. 19, 2012

(54) BRACE FOR A STEP OF A STEPLADDER AND A STEPLADDER EMPLOYING SUCH BRACES

(75) Inventors: Spencer GROSS, Louisville, KY (US); Abraham GÓMEZ LÓPEZ, Monterrey (MX)

(73) Assignee: Louisville Ladder Inc., Louisville, KY (US)

(21) Appl. No.: 12/904,624

(22) Filed: Oct. 14, 2010

(51) Int. Cl. E06C 7/10

(52) U.S. Cl. 182/217

(57) ABSTRACT

A bracing system for a bottom step of a stepladder has a first brace, a second brace, a second brace, a third brace and a fourth brace. The first brace has an end received in the channel of a side rail of the stepladder and an opposite end affixed to a front flange of the bottom step of the stepladder. A second brace has an end affixed in the channel of a side rail and an opposite end affixed to a front flange of the bottom step. The third brace has an end affixed to the channel of a side rail and an opposite end affixed to a back flange of the bottom step. The fourth brace has an end affixed to the channel of another of the side rails and an opposite end affixed to a back flange of the bottom step.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to bracing systems for stepladders. More particularly, the present invention relates to bracing systems in which four braces are utilized so as to structurally support the bottom step and the bottom rails of a stepladder. Additionally, the present invention relates to bracing systems for stepladders in which forces are transmitted from the bottom of the rails, through an intermediate structure in an effective manner to the bottom step of the stepladder so as to maximize the structural integrity of the bottom step and the rails of a stepladder.

2. Description of Related Art Including Information Disclosed Under 37 CFR 1.97 and 37 CFR 1.98.

Conventional stepladders are formed with at least a pair of side rails with steps extending therebetween. The side rails can typically be formed of a metal material having a generally U-shape. The side rails of this U-shaped channel face each other so as to receive the steps therebetween. Typically, the steps would be riveted to the side rails so that the ends of the steps are received within the channels of the side rails. The steps will extend in a generally horizontal plane in spaced relation to each other along each of the side rails.

During transport of a ladder, mishandling can occur which could result in deformation to the bottom end of the side rails, and the bottom step. Oftentimes, this mishandling results in the ladder being dropped from an elevation that causes a side-impact to the bottom of the ladder. This side-impact with a particular surface can cause the deformation to the bottom step. As such, an intermediate structure is needed to manage this side-impact loading.

The current intermediate structure is made of a certain steel alloy, and is relatively ineffective in managing side-impact loads through mishandling. Prior attempts to change the shape and material of this structure have been relatively ineffective. These prior techniques of providing an intermediate structure would fail, or not manage the side-impact energy to keep the bottom step from deforming. As such, an intermediate structure has been developed to efficiently manage this side-impact, as well as maintain overall ladder integrity.

In the past, various patents have issued relating to such bracing systems. For example, U.S. Pat. No. 4,049,082, issued on Sep. 20, 1997 to Reid, describes a structural member for a structural frame that has a substantially planar wall and two opposing irregular-shaped sidewalls integral with the planar wall. Each of the irregular-shaped sidewalls has a corrugation. The member has two free ends where the portion adjacent each free end is flattened. The corrugated sidewalls are adapted to fold upon themselves when a force is applied to an area of the member. The flattened portion is adapted to be secured by fastening means to components of the structural frame.

U.S. Pat. No. 4,834,216, issued on May 30, 1989 to Wallick, Jr. et al., describes a foldable ladder structure in which plastic material is injected and expanded in molds to form several parts of a foldable ladder. This includes front and rear ladder sections that can be pivotally hinged at their upper portions, a collapsible shelf and spreader linkage to allow the sections to be relatively pivoted from a collapsed face-to-face relation to an erected position. A flange area is formed adjacent to the bottom step so as to enhance the integrity of the bottom step.

U.S. Pat. No. 4,949,811 issued on Aug. 21,1990 to Bailey, shows a ladder brace that is provided which includes triangular-shaped braces extending between the bottom step and the side rails of the ladder. Each of these triangular-shaped members has an open interior, an upper portion positioned onto the bottom of the step, and a side wall positioned against the surface of the channel of the side rails.

U.S. Pat. No. 4,974,701, issued on Dec. 4, 1990, provides a stepladder construction includes a plurality of steps extending between a pair of struts. A coupling means joins each of the steps with the struts. Each of the struts has the shape of a channel with a pair of spaced webs between which the steps are received. The coupling means includes at least one flange element formed on one of the strut and the step, at least one surface defined on the other of the strut and the step to abut the flange element, and fastening means to fasten the step to the strut with the flange element against the surface. The fastening means constitutes means to maintain the flange element against the surface while the flange element constitutes means to transfer a substantial portion of loads appearing on the step to the strut to reduce the shear loads appearing on the fastening means.

U.S. Pat. No. 5,791,439, issued on Aug. 11, 1998 to Plotner et al., shows a member for connecting a rail to a horizontal element of a ladder. The member includes a first portion that connects to the horizontal member. The member also comprises a second portion which connects to the rail and extends essentially in parallel with the rail. The second portion is integrally connected to the first portion such that the first portion and the second portion are one continuous piece. The second portion is in an angular relationship of less than 90° with the first portion.

U.S. Pat. No. 7,516,817, issued on Apr. 14, 2009 to Pate et al., describes a knee brace for a ladder that includes a first flange and a second flange. The brace has a web extending from the first flange and the second flange so as to form a U-shaped cross-section. The brace has a first portion that connects to a step. The brace has a second portion which connects to the rail and terminates at a distance from a joint. The first and second flanges of the second portion and web present three contact surfaces which connect to the rail and extend essentially in parallel with the rail and conform with the rail to which the knee brace is attached so forces can be transferred therebetween. The first and second flanges contact a first rail flange and second rail flange, respectively, and the web contacts the web of the rail of U-shaped cross-section. The brace includes a first rivet extending through the first rail flange and first flange. The brace includes a second rivet extending through the second rail flange and the second flange adjacent the rail end.

U.S. Patent Publication No. 2005/0051386, published on Mar. 10, 2005 to D. Simpson, teaches a ladder support brace that has a curved structure that can be affixed to the underside of the step and affixed to the sides of the side rails.

It is an object of the present invention to a bracing system for the step of a stepladder which serves to transfer forces from the step to the side rails of the ladder.

It is another object of the present invention to provide a bracing system for the step of a stepladder which enhances the structural integrity of both the side rail and the step.

It is another object of the present invention to provide a bracing system for the step of a stepladder which is easy to manufacture, easy to assemble and relatively inexpensive.

These and other objects and advantages of the present invention will become apparent from a reading of the attached specification and appended claims.

### BRIEF SUMMARY OF THE INVENTION

The present invention is an apparatus that comprises a stepladder having a pair of side rails and a plurality of steps extending between the side rails. One of the pair of side rails has a channel facing a channel of the another of pair of side rails. The plurality of steps has a bottom step with ends respectively received in the channels of the pair of side rails. The bottom step has a channel facing downwardly. The channel is defined by a front flange and a back flange and a horizontal surface extending between the front flange and the back flange. A first brace has one end affixed in the channel in the one of pair of side rails and an opposite end affixed to the front flange of the bottom step. A second brace has one end affixed in the channel in the another of pair of side rails and an opposite end affixed to the front flange of the bottom step. A third brace has one end affixed in the channel of the side rail and an opposite end affixed to the back flange of the bottom step. Finally, a fourth brace has one end affixed in the channel of the pair of side rails and an opposite end affixed to the back flange of the bottom step.

In the present invention, each of the braces has an inner edge with a curvature extending between the end thereof and an outer edge extending between the ends thereof. Each of the braces has a first rib extending horizontally between the inner edge and the outer edge. A second rib extends horizontally between the inner edge and the outer edge in spaced relation to the first rib. The braces include a curved rib extending along a surface of the brace in spaced relation to the inner edge and the outer edge thereof. This curved edge can be positioned between the first rib and the second rib.

The outer edge of the braces of the present invention has a flange extending therealong in generally transverse relation to a surface of the brace. This flange extends horizontally at one end of the brace so as to reside adjacent an underside of the bottom step. The flange also extends horizontally at an opposite end of the brace. Each of the braces has holes formed therethrough adjacent to the respective opposite ends thereof.

The channel of each of the pair of side rails is defined by a forward flange and a rearward flange with an outer surface extending therebetween. The first brace is affixed to the forward flange of the side rails. One end of the second brace is affixed to the forward flange of this side rail. One end of the third brace is affixed to the rearward flange of the side rail. One end of the fourth brace is affixed to the rearward flange the side rail. Each of the braces has a planar face and an opposite face. The opposite face has a plurality of ribs extending horizontally thereacross.

The present invention is also a brace for use with a step of a stepladder. This brace has a body with a first surface and a second surface. The body has a first end suitable for connection to a side rail of the stepladder and a second end suitable for connection to the step of the stepladder. The body has an inner edge and an outer edge extending between the ends thereof. The outer edge has a flange formed therealong and extends generally transversely to the first surface. The flange has a first portion extending horizontally adjacent the first end and a second portion extending horizontally adjacent the second end. The second portion is suitable for positioning adjacent an underside of the step. The second surface has a first rib extending outwardly therefrom. The first rib extends horizontally across the second surface. The second surface has a second rib extending outwardly therefrom and extending generally horizontally thereacross in spaced relation to the first rib. The inner edge has a curvature extending between the ends thereof. The outer edge has a curvature extending between the ends thereof. There is a curved rib formed on the second surface. This curved rib is positioned between the inner edge and the outer edge. This curved rib also extends between the first rib and the second rib.

### BRIEF DESCRIPTION OF THE SEVERAL VIEWS OF THE DRAWINGS

FIG. 1 is a frontal view of the stepladder showing the bracing system of the present invention as applied to the bottom step thereof.

FIG. 2 is a bottom view of the stepladder of the present invention showing the bracing system of the present invention as applied thereto.

FIG. 3A shows a frontal view of one of the braces as used in the present invention.

FIG. 3B shows a rearward view of the brace of FIG. 3A.

FIG. 4A shows a forward view of another brace as used in the bracing system of the present invention.

FIG. 4B is a back view of the brace of FIG. 4A.

### DETAILED DESCRIPTION OF THE INVENTION

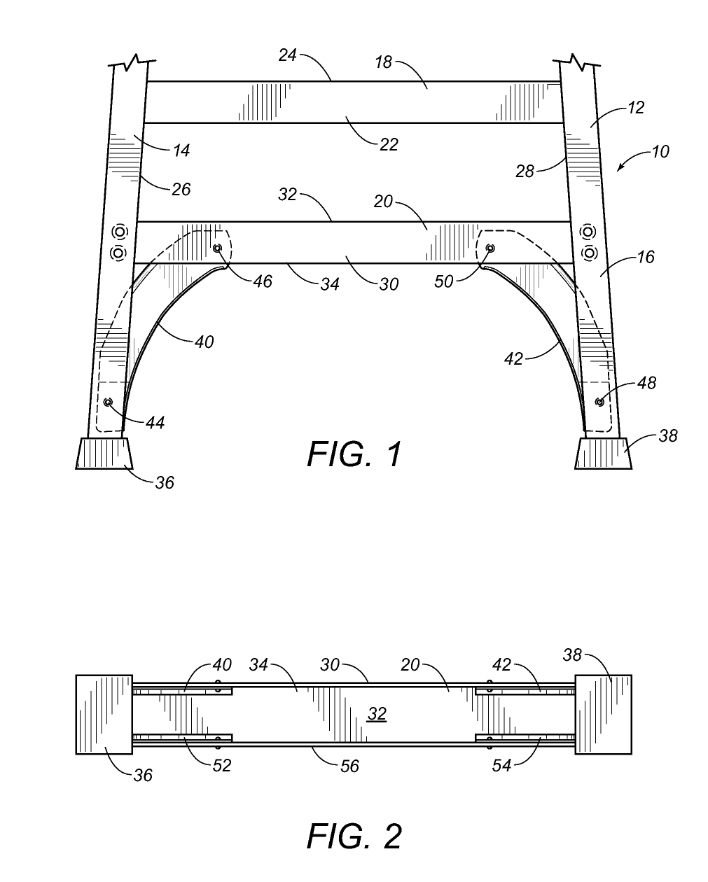

Referring to FIG. 1, there is shown in the bracing system 10 in accordance with the preferred embodiment of the present invention. The bracing system 10 is illustrated as applied to a conventional stepladder 12. The conventional stepladder has a structure that is known in the prior art. In particular, the stepladder 12 includes a first side rail 14 and a second side rails 16. The side rails 14 and 16 slightly taper toward each other from the bottom toward the top of the stepladder 12. Steps 18 and 20 extend between the side rails 14 and 16 and are in generally spaced parallel relationship to each other. The step 18 is located above the step 20. The step 18 has a conventional structure having a front flange 22 and a horizontal flat surface 24. There is another flange, such as flange 22, formed on the opposite side of the horizontal surface 24 (not illustrated in FIG. 1). The ends of the step 18 are received within the respective channels 26 and 28 of the side rails 14 and 16. The step 18 can be affixed within the channels 26 and 28 of the side rails 14 and 16 in a conventional manner, such as welding or riveting.

Importantly, in FIG. 1, it can be seen that the step 20 is the bottommost step of the stepladder 12. The step 20 is also secured in the channels 26 and 28 of the side rails 14 and 16, respectively. As such, the step 20 will extend generally horizontally. The step 20 includes a forward flange 30 that extends downwardly from a horizontal surface 32. The forward flange 30, along with a rearward flange (not illustrated), will define a channel 34 which opens downwardly.

In FIG. 1, the side rail 14 has an elastomeric foot 36 affixed thereto. Similarly, the side rail 16 has an elastomeric foot 38 affixed at a bottom thereof. The elastomeric feet 36 and 38 will serve to support the stepladder 12 upon an underlying surface. The channel 34 of the step 20 is arranged so as to face this underlying surface.

In FIG. 1, it can be seen that there is a first brace 40 that extends between the side rail 14 and the step 20. Another brace 42 extends between the side rail 16 and the step 20. The braces 40 and 42 are structurally affixed to the respective side rails 14 and 16 and to the step 20 so as to effectively support the step 20 against the forces that can be applied thereto. Braces 40 and 42 effectively transfer forces from the step 20 into the structure of the braces 40 and 42 and transfers the forces toward the side rails 14 and 16. As such, braces 40 and 42 strongly enhance the structure integrity of the bottom step 20.

The first brace 40 has one end affixed within the channel 26 of the side rail 14. A rivet 44 serves to strongly secure the first brace 40 within the channel 26 of the side rails 14 and 16. Another rivet 46 secures the opposite end of the brace 40 to the front flange 30 of the step 20. The second brace 42 has one end affixed within the channel 28 of the opposite side rail 16. Rivet 48 is attached to the second brace 42 so as to strongly secure the brace 42 to the wall of the channel 28. Another rivet 50 is affixed to the opposite end of brace 42 and to the front flange 30 of the step 20.

With reference to FIG. 1, it can be seen that when a force is applied to the top of step 20, the braces 40 and 42 will distribute a portion of this force to the side rails 14 and 16. The curved shape the braces 40 and 42 evenly distributes the force between the step 20 and the side rails. The flange will absorb certain forces so as to effectively avoiding the shearing of the respective rivets 46 and 50. As such, the present invention is able to prevent any deformations to the step 20 and to the side rails 14 and 16 when placed under load. Also, the curved shape of the braces 40 and 42 supports the structure of the side rails 14 and 16 when forces are applied to the side rails 14 and 16. For example, when the stepladder is dropped and a contact is made with a bottom of one of the side rails, the force is properly distributed toward and absorbed by the step 20. Once again, the structural integrity of the side rails is preserved by the present invention.

FIG. 2 shows that there is an arrangement of four braces 40, 42, 52 and 54 positioned between the step 20 and the respective side rails 14 and 16. The first brace 40 has one end affixed to the front flange 30 of step 20 and an opposite end affixed to the side rail 14. The second brace 42 has one end affixed to the front flange 30 of step 28 and an opposite end affixed to the side rail 16. The third brace 52 has one end affixed to the back flange 56 of step 20 and an opposite end affixed to the side rail 14. The fourth brace 54 has one end affixed to the back flange 56 of step 20 and an opposite end affixed to the side rail 16. The braces 40 and 52 extend in generally parallel relation to each other. The braces 42 and 54 extend in parallel relation to each other. Each of the braces 40, 42, 52 and 54 has a flange positioned against the underside of the step 20. FIG. 2 also shows that the elastomeric feet 36 and 38 have a generally rectangular bottom surface suitable for broadly distributing force against an underlying surface.

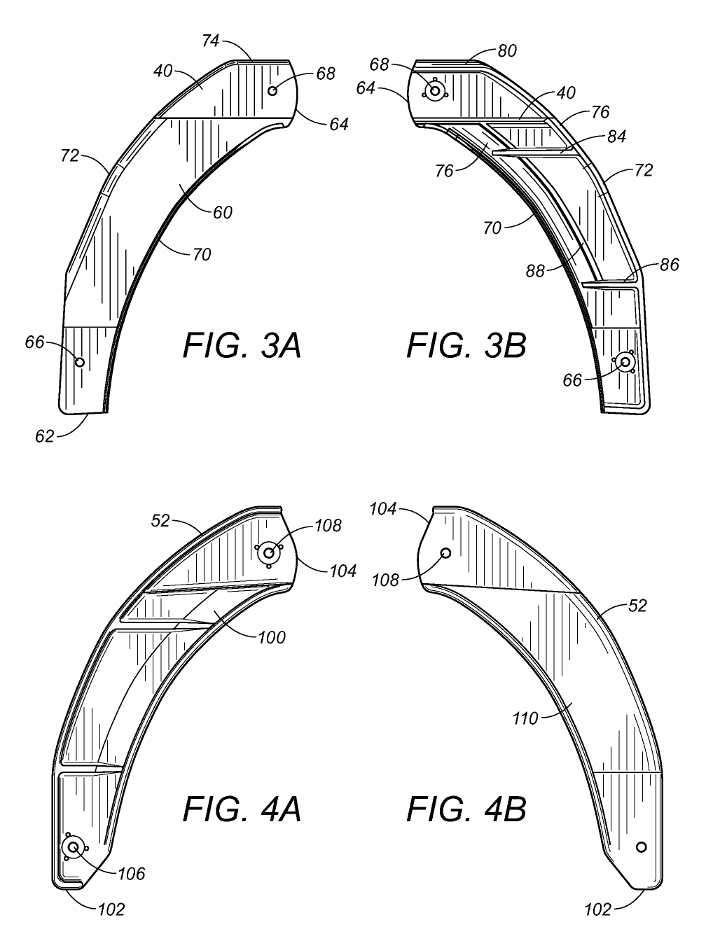

FIG. 3A is a side elevational and isolated view of the first brace 40. The second brace 42 will have a similar configuration as brace 40 but will be a mirror image thereof. In FIG. 3A, it can be seen that the first brace 40 has a generally planar surface 60 formed thereon. As such, this planar surface 60 will generally face the user of the stepladder 12 so as to present a very smooth appearance to the user. The first brace 40 has a first end 62 and a second end 64. The first end 62 will be secured to the first side rail 14. The second end 64 will be secured within the channel 34 of the step 20. There is a first hole 66 formed through the surface 60 adjacent to the first end 62. Another hole 68 is formed adjacent to the second end 64. Holes 66 and 68 serve to allow a rivet to be placed therein so as to be properly and securely affixed the first brace 40 to the side rail 14 and to the step 20.

The first brace 40 has an inner edge 70 and an outer edge 72. The inner 70 has a curvature extend from the first end 62 to the second end 64. The outer edge 72 also has a curvature generally extending from the first end 62. A generally flat surface 74 is formed near the second end 64. The flat surface 74 will be in a position generally adjacent to the horizontal surface 32 of the step 20. As such, this flat surface 74 can serve to establish a surface-to-surface contact with the step 20. The curvatures associated with the inner edge 70 and the outer edge 72 serve to effectively transfer forces from the second end 64 through the body of the first brace 70 to the side rail to the which the first end 62 is attached.

FIG. 3B shows the opposite surface 76 of the first brace 40. Holes 66 and 68 are illustrated are being formed adjacent to the respective ends 62 and 64 of the first brace 40. The surface 76 of the first brace 40 has a unique structure. It can be seen that there is a flange 78 that extends along the outer edge 72 of the first brace 40. Flange 78 extends generally transversely to the planar surface 60 and transversely to the opposite surface 76. The flange 78 has a generally flat surface 80 adjacent to the end 64. Flange 78 will provide an area of distribution with the underside of the step 20. The flange 72 also has a horizontal portion 82 formed at the end 62. A first rib 84 is formed on the first brace 40 and extends outwardly of the surface 76. Another rib 86 is also formed so as to extend outwardly of the surface 76. Rib 84 extends between the inner edge 70 and the outer edge 72. The first rib 84 is in parallel spaced relation to the second rib 86. Ribs 84 and 86 provide structure integrity to the first brace 40 and serve to enhance the integrity of the first brace 40 when placed under compression loads. These ribs 84 and 86 interact with the flange 78 so as to properly distribute forces across the body of the first brace 40.

A curved rib 88 will extend between the ribs 84 and 86. Curved rib 88 also extends outwardly of the surface 76. Rib 88 is in generally spaced relationship to the inner edge 70 and extends in a position between the inner edge 70 and the outer edge 72. The curved rib 88, once again, interacts with the structure of the horizontal ribs 84 and 86 so as to provide the relatively thin brace 40 with strong structured integrity and force distribution.

FIG. 4A is an illustration of the third brace 52. The fourth brace 54 will have a mirror-image construction identical to that of the brace 52. In FIG. 4A, it can be seen that the third brace 52 has a surface 100 extending between ends 102 and 104. Holes 106 and 108 are formed adjacent to respective ends 102 and 104. Holes 106 and 108 are suitable for allowing rivets to be affixed therethrough so as to properly secure the third brace 52 to the side rail 14 and to the step 20.

The third brace 52 has a construction very similar to that of the construction of first brace 40. The only difference between the third brace 52 and the first brace 40 is that the surface 108 adjacent to the end 104 has a shorter length than that of the flat surface 74 adjacent to the end 64 of the first brace 40. Since the third brace 52 (along with the fourth brace 54) are located at the back portion of the step 52, it is not necessary to provide such a long contact surface between the end 104 of the brace 52 and the step 20.

FIG. 4B shows an opposite side view of the third brace 52. The third brace 52 has a generally planer surface 110 thereon. This planar surface 110 will extend between end 102 and 104. As such, the third brace 52 will have a similar appearance to that of the first brace 40 (as shown in FIG. 3A).

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

We claim:

1. An apparatus comprising:
a stepladder having a pair of side rails and a plurality of steps extending between said pair of side rails, one of said pair of side rails having a channel facing a channel of another of said pair of side rails, said plurality of steps having a bottom step having a ends received respectively in the channels of said pair of side rails, said bottom step having a channel facing downwardly, said channel defined by a front flange and a back flange and a horizontal surface extending between said front flange and said back flange;
a first brace having one end affixed in said channel in said one of pair of side rails and an opposite end affixed to said front flange of said bottom step;
a second brace having one end affixed in said channel in said another of pair of side rails and an opposite end affixed to said front flange of said bottom step;
a third brace having one end affixed in said channel of said one of pair of side rails and an opposite end affixed to said back flange of said bottom step; and
a fourth brace having one end affixed in said channel of said another of said pair of side rails and an opposite end affixed to said back flange of said bottom step.

2. The apparatus of claim 1, each of said first, second, third and fourth braces comprising an inner edge having a curvature extending generally between said one end and said opposite end and an outer edge extending between said one end and said opposite end.

3. The apparatus of claim 2, each of said first, second, third and fourth braces having a first rib extending horizontally between said inner edge and said outer edge.

4. The apparatus of claim 3, each of said first, second, third and fourth braces having a second rib extending horizontally between said inner edge and said outer edge in spaced relation to said first rib.

5. The apparatus of claim 2, each of said first, second, third and fourth braces having a curved rib extending along a surface of the brace in spaced relation to said inner edge and said outer edge thereof.

6. The apparatus of claim 5, each of said first, second, third and fourth braces having a first rib extending horizontally between said inner edge and said outer edge, each of first, second, third and fourth braces having a second rib extending horizontally between said inner edge and said outer edge in spaced relation to said first rib, said curved rib extending between said first rib and said second rib.

7. The apparatus of claim 2, said outer edge having a flange extending therealong in generally transverse relation to a surface of the brace.

8. The apparatus of claim 7, said flange extending horizontally at said opposite end of the brace so as to reside adjacent an underside of said bottom step.

9. The apparatus of claim 8, said flange extending horizontally at said one end of the brace.

10. The apparatus of claim 1, each of said first, second, third and fourth braces having a first hole formed therethrough adjacent said one end thereof, each of said first, second, third and fourth braces having a second hole formed therethrough adjacent said opposite end thereof.

11. The apparatus of claim 1, the channel of each of said side rails being defined by a forward flange and a rearward flange with an outer surface extending therebetween, said one end of said first brace being affixed to said forward flange of the side rail, said one end of said second brace affixed to said forward flange of the side rail, said one end of said third brace affixed to the rearward flange the side rail, said one end of said fourth brace affixed to the rearward flange of the side rail.

12. The apparatus of claim 1, each of said first, second, third and fourth braces having a planar face and an opposite face, said opposite face having a plurality of ribs extending horizontally thereacross.

13. A brace for use with a step of a stepladder, the brace comprising:
a body having a first surface and a second surface, said body having a first end suitable for connection to a side rail of the stepladder and a second end suitable for connection to the step of the stepladder, said body having an inner edge and an outer edge extending between said first end and said second end, said outer edge having a flange formed therealong and extending generally transversely to said first surface.

14. The brace of claim 13, said flange having a first portion extending horizontally adjacent said first end and a second portion extending horizontally adjacent said second end, said second portion suitable for positioning adjacent an underside of the step.

15. The brace of claim 13, said second surface having a first rib extending outwardly therefrom, said first rib extending horizontally across said second surface.

16. The brace of claim 15, said second surface having a second rib extending outwardly therefrom and extending generally horizontally thereacross in spaced relation to said first rib.

17. The brace of claim 13, said inner edge having a curvature extending between said first and second ends thereof, said outer edge having a curvature extending between said first and second ends thereof.

18. The brace of claim 17, said second surface having a curved rib formed thereon, said curved rib positioned between said inner edge and said outer edge.

19. The brace of claim 15, said second surface having a curved rib extending between said first rib and said second rib.

20. The brace of claim 13, said body having a first hole formed adjacent said first end, said body having a second hole adjacent said first end, said body having a second hole formed adjacent said second end, each of said first and second holes suitable for receiving respective rivets therein.
